(19) United States
(12) Patent Application Publication
(10) Pub. No.: US 2016/0283562 A1
(43) Pub. Date: Sep. 29, 2016

(54) COMMUNITY POLICING VIA MULTI-PLATFORM INTEGRATION

(71) Applicant: International Business Machines Corporation, Armonk, NY (US)

(72) Inventors: Gokul B. Alex, Kollam (IN); Joyil Joseph, Bangalore (IN)

(21) Appl. No.: 14/667,881

(22) Filed: Mar. 25, 2015

(51) Int. Cl. G06F 17/30; G06N 99/00; G06F 17/27

(52) U.S. Cl. CPC G06F 17/30539; G06F 17/30864; G06F 17/2785; G06N 99/005

(57) ABSTRACT

Aspects of the present invention disclose a method for event discovery based on semantic patterns. The method includes one or more processors receiving data from one or more devices. The method further includes one or more processors generating one or more semantic patterns from the data. The method further includes one or more processors comparing the one or more new semantic patterns to one or more existing semantic patterns. The method further includes one or more processors determining whether the one or more new semantic patterns are substantially unique based on the comparison.

### BACKGROUND OF THE INVENTION

The present invention relates generally to the field of computer networking, and more particularly to combining cognitive learning and social media data-mining to assist in community policing.

Community policing is a strategy that focuses on cooperation and building ties between the police and the local community. Key to this strategy is collecting social media data, the use of cognitive learning capabilities in modern computers, and data-mining large quantities of existing data. Social media data refers to all forms of data collected on social media platforms and via public sensors. Types of social media data can be social profile information, social media messages, text messages, photo sharing and the like. Public sensor data can include items such as surveillance cameras, which monitor public spaces like sidewalks and intersections (red light cameras), mass transit terminals, subsidized housing projects, etc., and video cameras in police cars or body cameras worn by members of law enforcement. Cognitive learning is the refining of knowledge by adding new information to existing knowledge. Data-mining is an analytic process designed to explore data in search of consistent patterns and/or systematic relationships between variables, and then to validate the findings by applying the detected patterns to new subsets of data. This collection of information can help in the formulation of semantic patterns. In Information Technology (IT), semantic refers to the information contained within data. By extension, the semantic pattern can be the latent pattern of information within the social media data.

### SUMMARY

Aspects of the present invention disclose a method for event discovery based on semantic patterns. The method includes one or more processors receiving data from one or more devices. The method further includes one or more processors generating one or more semantic patterns from the data. The method further includes one or more processors comparing the one or more new semantic patterns to one or more existing semantic patterns. The method further includes one or more processors determining whether the one or more new semantic patterns are substantially unique based on the comparison.

### BRIEF DESCRIPTION OF THE DRAWINGS

FIG. 1 is a functional block diagram of a data processing environment in accordance with an embodiment of the present invention.

FIG. 2 is a flowchart depicting operational steps of an application or plurality of applications that function to generate and analyze semantic patterns within data, compare those patterns with pre-existing patterns to determine a conclusion, and send notifications based on the conclusion, in accordance with an embodiment of the present invention.

FIG. 3 depicts a block diagram of the components of a computing system representative of the client device and servers of FIG. 1, in accordance with an embodiment of the present invention.

### DETAILED DESCRIPTION

Some embodiments of the present invention recognize that social media, while a form of convenient communication, has additional benefits. The public can live, work, and play in a safer environment by taking advantage of social media data.

Combining commercial security products, which are readily available in the marketplace, with semantic patterns gleaned from social media data and/or public sensor data, cognitive learning, and data-mining, assists local law enforcement in making communities safer by way of more accurate and efficient event detection. Examples of events can be a building fire, an automobile crash, a gathering mob, a crime in progress, a tornado, a flood, etc. Social media data from sources such as Twitter® messages, Instagram® photos, instant messages (IMs), Internet chat, and the like is available. Public sensor data from sources such as surveillance cameras in public spaces such as road intersections and airports, global positioning system (GPS) trackers, body cameras worn by members of law enforcement, and the like, is also available. Studying this data can reveal semantic patterns, which is the information contained within the social media data. The semantic patterns can also aid in predicting future events via cognitive learning. The refining of knowledge, by adding new information to existing knowledge, is one definition of cognitive learning.

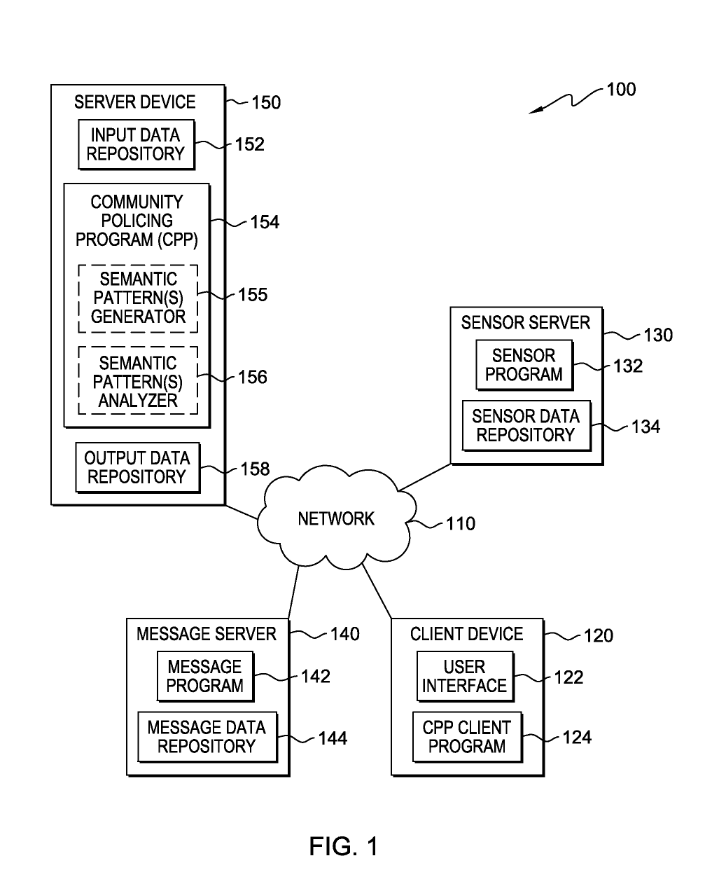

The present invention will now be described in detail with references to the Figures. FIG. 1 is a functional block diagram of a data processing environment, generally designated 100, in accordance with one embodiment of the present invention.

An embodiment of data processing environment 100 includes client device 120, sensor server 130, message server 140 and server device 150, interconnected over network 110. In an example embodiment, utilizing network 110, sensor server 130 and message server 140 can communicate with server device 150 which in turn can communicate with client device 120. In example embodiments, data processing environment 100 can include other computing devices not shown such as desktop computers, laptop computers, computer servers or any other computer systems known in the art.

Network 110 can be a local area network (LAN), a telecommunications network, a wide area network (WAN) such as the Internet, or any combination of the three, and include wired, wireless or fiber optic connections. In general, network 110 can be any combination of connections and protocols that will support communications between client device 120, sensor server 130, message server 140 and server device 150, in accordance with embodiments of the present invention.

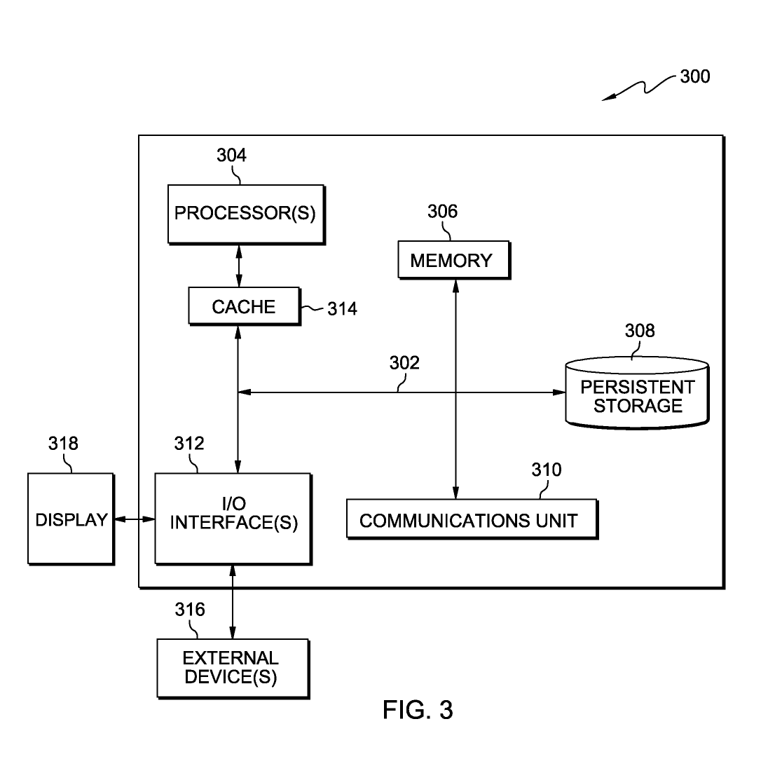

In various embodiments of the present invention, client device 120 can be a workstation, personal computer, personal digital assistant (PDA), mobile phone, or any other device capable of executing computer readable program instructions, in accordance with embodiments of the present invention. In general, client device 120 is representative of any electronic device or combination of electronic devices capable of executing computer readable program instructions. Client device 120 can include components as depicted and described in further detail with respect to FIG. 3, in accordance with embodiments of the present invention.

Client device 120 includes user interface 122 and Community Policing Program (CPP) client program 124. User interface 122 can be a program that controls input to client device 120 via a plurality of devices, such as a keyboard, a mouse, a touch screen, a microphone, etc. In example embodiments, CPP client program 124 can communicate with Community Policing Program (CPP) 154, message program 142 and/or sensor program 132, over network 110. In general, CPP client program 124 is any type of program that allows a user of client device 120, via user interface 122, to access data on server device 150, and is capable of communicating with Community Policing Program (CPP) 154.

In example embodiments, sensor server 130 can be a desktop computer, computer server or any other computer system known in the art. In certain embodiments, sensor server 130 represents computer systems utilizing clustered computers and components (e.g., database server computers, application server computers, etc.) that act as a single pool of seamless resources when accessed by elements of data processing environment 100 (e.g., client device 120). In general, sensor server 130 is representative of any electronic device or combination of electronic devices capable of executing computer readable program instructions. Sensor server 130 may include components as depicted and described in further detail with respect to FIG. 3, in accordance with embodiments of the present invention.

Sensor server 130 includes sensor program 132 and sensor data repository 134. In various embodiments of the present invention, sensor server 130 can control sensor functions, via sensor program 132, and can store sensor data, to sensor data repository 134, from a plurality of sensors.

In various embodiments, types of sensors controlled by sensor program 132 can include digital cameras for capturing still images and/or audio/video recordings, closed circuit television (CCTV) systems capturing audio/video recordings, radio frequency identification (RFID) readers, motion sensors, heat sensors, noise sensors or any other device capable of collecting and/or storing data. Sensor data captured can be in the form of a still image file, audio file, video file, audio/video file, text file, identification data, etc. In example embodiments, individual sensors can communicate with sensor server 130 and sensor program 132 over network 110. In general, sensor server 130 is representative of any electronic device capable of collecting and storing data.

In one embodiment, sensor program 132 can be an application capable of controlling how a plurality of sensors function. In an example embodiment, sensor program 132 can be the application software that controls when a video camera captures video. For example, a video camera can run continuously, only if motion is detected, only at night, etc. Sensor program 132 can define parameters of when sensor data is stored to sensor data repository 134. In one embodiment, sensor data repository 134 receives sensor data as soon as one of a plurality of sensors captures the data. Alternatively, sensor data can be stored to sensor data repository 134 at the top of every hour, or once per day, or when prompted by CPP client program 124.

Sensor data repository 134 can be storage that can be written to and/or read by sensor program 132 and server device 150. Sensor data captured by a sensor can be stored to sensor data repository 134. For example, video footage, the time the footage was captured, the duration of the footage, and other information, can be stored to sensor data repository 134. In one embodiment, sensor data repository 134 resides on sensor server 130. In other embodiments, sensor data repository 134 can reside in cloud storage, on another computing device server, or on server device 150, provided that sensor data repository 134 is accessible to server device 150 via network 110.

In example embodiments, message server 140 can be a desktop computer, computer server, smartphone, tablet computer or any other computer system known in the art. In certain embodiments, message server 140 represents computer systems utilizing clustered computers and components (e.g., database server computers, application server computers, etc.) that act as a single pool of seamless resources when accessed by elements of data processing environment 100 (e.g., client device 120). In general, message server 140 is representative of any electronic device or combination of electronic devices capable of executing computer readable program instructions. Message server 140 may include components as depicted and described in further detail with respect to FIG. 3, in accordance with embodiments of the present invention.

Message server 140 includes message program 142 and message data repository 144. In one embodiment of the present invention, message server 140 can send and receive messages, via message program 142, and can store message data, to message data repository 144, from a plurality of messaging devices.

In various embodiments, types of messaging devices interacting with message program 142 can include cell phones, smartphones, desktop computers, laptop computers, tablet computers, or any other device capable of creating, sending, receiving and storing messages. Messages can be in the form of a text, a photo, an online chat conversation, etc. In example embodiments, individual message devices can communicate with message server 140 over network 110. In general, messaging devices are representative of any electronic device capable of creating, sending, receiving and storing messages.

In one embodiment, message program 142 can be an application capable of sending, receiving, and storing a plurality of messages. In an example embodiment, message program 142 can be application software that manages communication between devices using a texting application. Message program 142 can define the parameters of when message data is stored to message data repository 144. In one embodiment, message data can be sent to message data repository 144 for every message sent by one of a plurality of messaging devices.

Message data repository 144 can be storage that can be written to by message program 142 and server device 150. Message data created by a messaging device can be stored to message data repository 144. For example, a text message, the time of the text message and the message distribution list can be stored to message data repository 144. In one embodiment, message data repository 144 resides on message server 140. In other embodiments, message data repository 144 can reside in cloud storage, on another computing device server within data processing environment 100, or on server device 150 provided that message data repository 144 is accessible to server device 150 via network 110.

In example embodiments, server device 150 can be a desktop computer, laptop computer, computer server or any other computer system known in the art. In certain embodiments, server device 150 represents computer systems utilizing clustered computers and components (e.g., database server computers, application server computers, etc.) that act as a single pool of seamless resources when accessed by elements of data processing environment 100 (e.g., client device 120). In general, server device 150 is representative of any electronic device or combination of electronic devices capable of executing computer readable program instructions. Server device 150 can include components as depicted and described in further detail with respect to FIG. 3, in accordance with embodiments of the present invention.

Server device 150 includes input data repository 152, Community Policing Program (CPP) 154, comprised of semantic pattern(s) generator 155, semantic pattern(s) analyzer 156, and output data repository 158. In one embodiment, server device 150 is a component of an information center which stores a plurality of data that can be stored in a chronological format. For example, input data repository 152 contains a plurality of sensor data from sensor server 130 and message data from message server 140. Input data repository 152 and output data repository 158 can each be implemented as a database, a collection of files, a knowledge base, an expert system, etc., residing on a database server, a hard disk drive, flash memory, and the like. In other embodiments, input data repository 152 and output data repository 158 can each represent multiple storage devices within server device 150.

In one embodiment Community Policing Program (CPP) 154 can be an application or plurality of applications that function to generate and analyze semantic patterns within data, compare those patterns with pre-existing patterns to determine a conclusion, and send notifications based on the conclusion. The comparison can be done in a machine-to-machine (M2M) environment with human feedback to substantiate a reasonable, well-founded conclusion. Data to be analyzed can reside in input data repository 152 and the conclusion to the analysis can be stored to output data repository 158. Community Policing Program (CPP) 154 contains, or has access to semantic pattern(s) generator 155 and semantic pattern(s) analyzer 156. In general, Community Policing Program (CPP) 154 is any application or plurality of applications capable of analyzing input data, comparing input data with existing data, sending notifications based on the comparison, and storing the new data analysis for use in the future. In one embodiment, Community Policing Program (CPP) 154 performs analysis on sensor data, such as video footage, from sensor server 130. In other embodiments, Community Policing Program (CPP) 154 performs analysis on message data, such as cell phone text messages, from message server 140. In some embodiments, Community Policing Program (CPP) 154 performs analysis on both sensor data and message data.

In some embodiments, Community Policing Program (CPP) 154 generates an analysis from data contained in input data repository 152 and stores the analysis to output data repository 158. In one embodiment, the analysis can be indicative of a commonplace event. A commonplace event is one which occurs often and is not any cause for concern. In other embodiments, the analysis can be indicative of a known issue requiring distribution of a notification. A known issue is an event where there is cause for concern over an individual's well-being or property. In some embodiments, the notification can be received at a central location, such as client device 120, and interpreted by a user of CPP client program 124. In other embodiments, mobile devices, such as smartphones, two-way radios, laptop computers, tablet computers, etc., can receive the notification.

In accordance with embodiments of the present invention, semantic pattern(s) generator 155 can be an application which determines a new semantic pattern(s) from raw data. In various embodiments, the data utilized by semantic pattern(s) generator 155 can be sensor data, received from sensor server 130, message data, received from message server 140 or a combination of both. An example of a semantic pattern is the knowledge that an increase in the amount of text message traffic regarding a large gathering of people in a local park on July 4^{th} is simply an indication of a commonplace event. Semantic pattern(s) generator 155 can retrieve the data from input data repository 152 on server device 150, in accordance with embodiments of the present invention. In example embodiments, any number of new semantic patterns (first, second, etc.) generated by semantic pattern(s) generator 155 can be stored to output data repository 158.

In various embodiments, semantic pattern(s) analyzer 156 can be an application which analyzes semantic patterns generated by semantic pattern(s) generator 155. In example embodiments, semantic pattern(s) analyzer 156 analyzes existing and newly generated semantic patterns for common and uncommon traits, characteristics that are similar and/or features that are dissimilar. Analyzing these patterns can enable future event predictions based on the data collected by sensor server 130 and message server 140, in accordance with embodiments of the present invention. In one embodiment, the ability to predict events, based on capabilities of semantic pattern(s) analyzer 156, such as natural language processing, cognitive learning, and the like, is a critical feature of the present invention. In example embodiments, any conclusions and/or predictions from semantic pattern(s) analyzer 156 can be stored to output data repository 158.

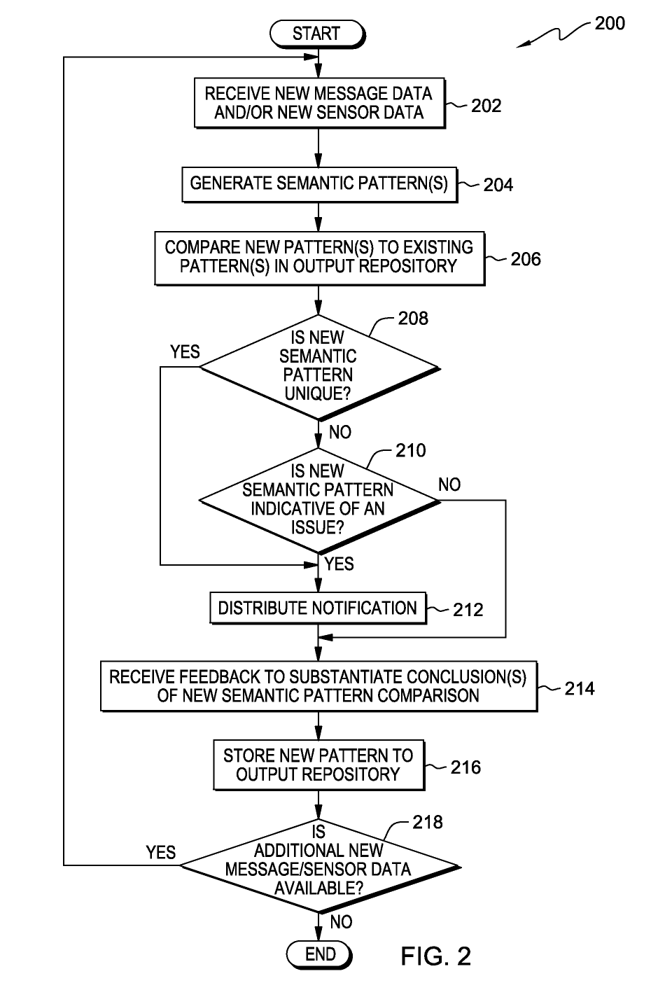

FIG. 2 is a flowchart depicting operational steps 200 of Community Policing Program (CPP) 154, an application or plurality of applications that function to generate and analyze semantic patterns within data, compare those patterns with pre-existing patterns to determine a conclusion, and send notifications based on the conclusion. In one embodiment, Community Policing Program (CPP) 154 initiates in response to receiving input data from sensor server 130 and/or message server 140. In another embodiment, Community Policing Program (CPP) 154 can initiate in response to user input to CPP client program 124 on client device 120.

In step 202, Community Policing Program (CPP) 154 receives new message data and/or new sensor data. In one embodiment, new data can be received automatically from input data repository 152. In another embodiment, Community Policing Program (CPP) 154 can query sensor server 130 and/or message server 140 for new data. In other embodiments, CPP client program 124, residing in client device 120, can prompt Community Policing Program (CPP) 154, via user input, to query input data repository 152 for new data. For example, Community Policing Program (CPP) 154 can receive text messages from smartphone users and/or video footage from a convenience store closed-circuit television (CCTV) system.

In step 204, Community Policing Program (CPP) 154 generates a semantic pattern from the sensor and/or message data received in step 202. In various embodiments, semantic patterns can be generated via key features of Community Policing Program (CPP) 154 such as, natural language processing (NLP) capability and cognitive learning. In Information Technology (IT), semantic refers to the information contained within data. By extension, the semantic pattern can be the latent pattern of information within the data. Natural language processing is a field of computer science, artificial intelligence, and linguistics concerned with the interactions between computers and human (natural) languages. Cognitive learning can be defined as the refining of knowledge by adding new information to prior knowledge. For example, if data received by Community Policing Program (CPP) 154 is a large volume of text messages, comments about a building fire in a plurality of the text messages can be the semantic pattern.

In step 206, Community Policing Program (CPP) 154 performs a comparison of the newly generated semantic pattern against those already existing in output data repository 158. In one embodiment, the resultant comparison shows a particular event to be normal and routine (e.g., commonplace). For example, a series of photos may show a crowd gathering in a park on the 4^{th} of July. A crowd forming could be indicative of a problem but the fact that it is occurring on July 4^{th} suggests this to be a normal occurrence since historical data shows a similar gathering of people in the same location on the same date for the past decade. Common characteristics of the photo metadata can be the time stamp and location information. In another embodiment, the resultant comparison determines an event to be indicative of a known issue. Consider again the building fire example above. Community Policing Program (CPP) 154 has “learned” over time, via cognitive learning, that any mention of the word “fire” in multiple text messages can be the result of a known issue. The metadata in this example can be the large number of texts sent in a short period of time all containing the word “fire”.

In decision step 208, Community Policing Program (CPP) 154 determines whether the new semantic pattern is substantially unique (i.e., unique to a significant extent, a minimal overlap of the pattern characteristics) based on the pattern comparison performed in step 206. If Community Policing Program (CPP) 154 determines that the new semantic pattern is substantially unique (e.g., an event not observed before) (step 208, YES branch), then the program distributes a notification (step 212). If Community Policing Program (CPP) 154 determines that the new semantic pattern is not substantially unique but rather considered commonplace (step 208, NO branch), then the program proceeds to decision step 210.

In decision step 210, Community Policing Program (CPP) 154 determines whether the new semantic pattern is indicative of an issue based on the conclusion reached in decision step 208 that the pattern is commonplace (e.g., not substantially unique). In one embodiment, Community Policing Program (CPP) 154 analyzes the new semantic pattern against stored patterns and other metadata corresponding to the stored patterns contained in output data repository 158. The metadata can contain information such as a time stamp or a location. For example, if the location data of a crowd forming is shown in the metadata to be a local park, it may indicate that the gathering is simply a family picnic. If Community Policing Program (CPP) 154 determines that the new semantic pattern is indicative of an issue (step 210, YES branch), then the program distributes a notification (step 212). If Community Policing Program (CPP) 154 determines that the new semantic pattern is not indicative of an issue (step 210, NO branch), then the program continues operation at step 214.

In step 212, Community Policing Program (CPP) 154 distributes a notification. In one embodiment, Community Policing Program (CPP) 154 distributes a notification if a new semantic pattern is substantially unique or indicative of an issue. If the new semantic pattern is substantially unique, the notification can be sent to multiple agencies, or possibly a central command location, for further investigation. If the new semantic pattern is indicative of an issue, the notification can be sent directly to the agency (or agencies) responsible for resolving the issue. For example, in the building fire scenario, since a fire can cause loss of property, Community Policing Program (CPP) 154 notifies the local Fire Department and Police Department. Community Policing Program (CPP) 154 can also have “learned”, through past fire events, that injuries and/or loss of life can occur so the program notifies the local Ambulance Service as well. In an example embodiment, client device 120 receives the notification and CPP client program 124 processes the notification.

In step 214, Community Policing Program (CPP) 154 receives feedback from a reviewer confirming (i.e., to substantiate) whether the conclusions reached by the program are well-founded and reasonable. This “sanity check” provides a form of cognitive learning by Community Policing Program (CPP) 154 so that the program continuously updates with the latest information enabling it to be more accurate and predictive in the future when similar events occur. For example, Community Policing Program (CPP) 154 will not distribute a notification if the program determines semantic pattern “A” as not substantially unique (step 208, NO branch) and not an issue (step 210, NO branch). However, this feedback loop provides a correction to output data repository 158 if this “non-unique, non-issue” pattern was characterized incorrectly. This ensures that the contents of output data repository 158 contains accurate information (in regard to both the original semantic pattern “A” and the corrected information concerning how pattern “A” was characterized) and in a reoccurrence of semantic pattern “A”, a notification would now be distributed. In one embodiment, a user of client device 120 provides the reviewer feedback; the user would see the error in the conclusion and provide a correction to output data repository 158, for future reference.

In step 216, Community Policing Program (CPP) 154 stores the result of the pattern comparison (from step 206), along with any associated reviewer feedback provided in step 214, to output data repository 158. In one embodiment, the comparison by Community Policing Program (CPP) 154 has determined the new semantic pattern to be commonplace; for example, the 4^{th} of July crowd gathering in the local park. In another embodiment, the comparison by Community Policing Program (CPP) 154 has determined the new semantic pattern to be indicative of an issue which required a notification; for example, the building fire.

In decision step 218, Community Policing Program (CPP) 154 performs an action based on the availability of new message and/or sensor data. In one embodiment, if Community Policing Program (CPP) 154 determines new message and/or sensor data has been stored to input data repository 152 (step 218, YES branch), then the program receives the new data (step 202). In another embodiment, if Community Policing Program (CPP) 154 finds no new message and/or sensor data available (step 218, NO branch), then the program terminates until the program receives new data.

FIG. 3 depicts a block diagram of components of computer 300, which is representative of client device 120, sensor server 130, message server 140, and server device 150, in accordance with an illustrative embodiment of the present invention. It should be appreciated that FIG. 3 provides only an illustration of one implementation and does not imply any limitations with regard to the environments in which different embodiments can be implemented. Many modifications to the depicted environment can be made.

Computer 300 includes processor(s) 304, cache 314, memory 306, persistent storage 308, communications unit 310, input/output (I/O) interface(s) 312 and communications fabric 302. Communications fabric 302 provides communications between cache 314, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer readable storage media. In this embodiment, memory 306 includes random access memory (RAM). In general, memory 306 can include any suitable volatile or non-volatile computer readable storage media. Cache 314 is a fast memory that enhances the performance of processor(s) 304 by holding recently accessed data, and data near recently accessed data, from memory 306. With respect to client device 120, persistent storage 308 includes user interface 122 and CPP client program 124. With respect to sensor server 130, persistent storage 308 includes sensor program 132 and sensor data repository 134. With respect to message server 140, persistent storage 308 includes message program 142 and message data repository 144. With respect to server device 150, persistent storage 308 includes input data repository 152, Community Policing Program (CPP) 154 and output data repository 158.

In this embodiment, persistent storage 308 includes a magnetic hard disk drive. Alternatively, or in addition to a magnetic hard disk drive, persistent storage 308 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

Communications unit 310, in these examples, provides for communications with other data processing systems or devices, including resources of client device 120, sensor server 130, message server 140, and server device 150. In these examples, communications unit 310 includes one or more network interface cards. Communications unit 310 may provide communications through the use of either or both physical and wireless communications links. In various embodiments, user interface 122, CPP client program 124, sensor program 132, sensor data repository 134, message program 142, message data repository 144, input data repository 152, Community Policing Program (CPP) 154, and output data repository 158 can be downloaded to persistent storage 308 through communications unit 310.

I/O interface(s) 312 allows for input and output of data with other devices that may be connected to computer 300. For example, I/O interface(s) 312 may provide a connection to external device(s) 316 such as a keyboard, a keypad, a touch screen, and/or some other suitable input device. External device(s) 316 can also include portable computer readable storage media such as, for example, thumb drives, portable optical or magnetic disks, and memory cards. Software and data used to practice embodiments of the present invention, (e.g., CPP client program 124, sensor program 132, sensor data repository 134, message program 142, message data repository 144, input data repository 152, Community Policing Program (CPP) 154, and output data repository 158), can be stored on such portable computer readable storage media and can be loaded onto persistent storage 308 via I/O interface(s) 312. I/O interface(s) 312 also connect to a display 318.

Display 318 provides a mechanism to display data to a user and may be, for example, a computer monitor. Display 318 can also function as a touchscreen, such as a display of a tablet computer.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

1. A method for event discovery, based on semantic patterns, the method comprising:
receiving, by one or more processors, data from one or more devices;
generating, by one or more processors, one or more semantic patterns, from the data;
comparing, by one or more processors, the one or more semantic patterns to existing semantic patterns; and
determining, by one or more processors, whether the one or more semantic patterns are substantially unique based on the comparison.

2. The method of claim 1, wherein the data includes at least one of public sensor data and social media data.

3. The method of claim 1, wherein the step of generating, by one or more processors, one or more semantic patterns, from the data, comprises:
analyzing the data to generate one or more semantic patterns, using one or more of the following capabilities: natural language processing; cognitive learning; and data-mining.

4. The method of claim 1, wherein the step of comparing, by one or more processors, the one or more generated semantic patterns, to existing semantic patterns, comprises:
retrieving the existing semantic patterns from a repository;
retrieving the one or more generated semantic patterns from the repository; and
comparing the existing semantic patterns and the one or more generated semantic patterns by analyzing metadata of each of the existing semantic patterns and generated semantic patterns for characteristics.

5. The method of claim 1, further comprising:
determining that a first semantic pattern, of the one or more semantic patterns, is substantially unique;
distributing a notification that the first semantic pattern is substantially unique; and
receiving an indication from a reviewer confirming that the first semantic pattern is substantially unique.

6. The method of claim 1, further comprising:
determining that a second semantic pattern, of the one or more semantic pattern, is not substantially unique;
determining that the second semantic pattern, of the one or more semantic patterns, is cause for concern;
distributing a notification that the second semantic pattern is not substantially unique but is cause for concern; and
receiving an indication from a reviewer confirming that the second semantic pattern is not substantially unique but is cause for concern.

7. The method of claim 2, wherein the one or more devices include one or more of: surveillance cameras in public; radio frequency identification readers; global positioning system trackers; law enforcement body cameras; video cameras in vehicles; motion sensors; heat sensors, and noise sensors.

8. The method of claim 2, wherein the social media data include messages from one or more of: cell phones; smartphones; tablet computers; laptop computers; desktop computers; social media applications sending text messages, and photo messages.

9. A computer program product for event discovery based on semantic patterns, the computer program product comprising:
one or more computer readable storage media, program instructions stored on the one or more computer readable storage media, the program instructions comprising:
program instructions to receive data from one or more devices;
program instructions to generate one or more semantic patterns from the data;
program instructions to compare the one or more generated semantic patterns to existing semantic patterns; and
program instructions to determine whether the one or more generated semantic patterns are substantially unique based on the comparison.

10. The computer program product of claim 9, wherein the data includes at least one of public sensor data and social media data.

11. The computer program product of claim 9, wherein the program instructions to generate one or more semantic patterns from the data comprise:
program instructions to analyze the data to generate one or more semantic patterns, using one or more of the following capabilities: natural language processing; cognitive learning; and data-mining.

12. The computer program product of claim 9, wherein the program instructions to compare the one or more generated semantic patterns to existing semantic patterns comprise:
retrieving the existing semantic patterns from a repository;
retrieving the one or more generated semantic patterns from the repository; and
comparing the existing semantic patterns and the one or more generated semantic patterns by analyzing metadata of each of the existing semantic patterns and generated semantic patterns for characteristics.

13. The computer program product of claim 9, further comprising program instructions, stored on the one or more computer readable storage media, to:
determine that a first semantic pattern, of the one or more semantic patterns, is substantially unique;
distribute a notification that the first semantic pattern is substantially unique; and
receive an indication from a reviewer confirming that the first semantic pattern is substantially unique.

14. The computer program product of claim 9, further comprising program instructions, stored on the one or more computer readable storage media, to:
determine that a second semantic pattern, of the one or more semantic patterns, is not substantially unique;
determine that the second semantic pattern, of the one or more semantic patterns, is cause for concern;
distribute a notification that the second semantic pattern is not substantially unique but is cause for concern; and
receive an indication from a reviewer confirming that the second semantic pattern is not substantially unique but is cause for concern.

15. A computer system for event discovery based on semantic patterns, the computer system comprising:
one or more computer processors;
one or more computer readable storage media; and
program instructions stored on the computer readable storage media for execution by at least one of the one or more processors, the program instructions comprising:
program instructions to receive data from one or more devices;
program instructions to generate one or more semantic patterns from the data;
program instructions to compare the one or more semantic patterns to existing semantic patterns; and
program instructions to determine whether the one or more semantic patterns are substantially unique based on the comparison.

16. The computer system of claim 15, wherein the data includes at least one of public sensor data and social media data.

17. The computer system of claim 15, wherein the program instructions to generate one or more semantic patterns, from the data, comprise:
program instructions to analyze the data to generate one or more semantic patterns, using one or more of the following capabilities: natural language processing; cognitive learning; and data-mining.

18. The computer system of claim 15, wherein the program instructions to compare the one or more generated semantic patterns to existing semantic patterns, comprise:
retrieving the existing semantic patterns from a repository;
retrieving the one or more generated semantic patterns from the repository; and
comparing the existing semantic patterns and the one or more generated semantic patterns by analyzing metadata of each of the existing semantic patterns and generated semantic patterns for characteristics.

19. The computer system of claim 15, further comprising program instructions, stored on the one or more computer readable storage media for execution by at least one of the one or more processors, to:
determine that a first semantic pattern, of the one or more semantic patterns, is substantially unique;
distribute a notification that the first semantic pattern is substantially unique; and
receive an indication from a reviewer confirming that the first semantic pattern is substantially unique.

20. The computer system of claim 15, further comprising program instructions, stored on the one or more computer readable storage media for execution by at least one of the one or more processors, to:
determine that a second semantic pattern, of the one or more semantic patterns, is not substantially unique;
determine that the second semantic pattern, of the one or more semantic patterns, is cause for concern;
distribute a notification that the second semantic pattern is not substantially unique but is cause for concern; and
receive an indication from a reviewer confirming that the second semantic pattern is not substantially unique but is cause for concern.
